(19) United States
(12) Patent Application Publication
(10) Pub. No.: US 2025/0336568 A1
(43) Pub. Date: Oct. 30, 2025

(54) COMMUNICATION CABLE

(71) Applicant: Yazaki Corporation, Tokyo (JP)

(72) Inventor: Daisuke SUZUKI, Shizuoka (JP)

(73) Assignee: Yazaki Corporation, Tokyo (JP)

(21) Appl. No.: 19/184,151

(22) Filed: Apr. 21, 2025

(30) Foreign Application Priority Data
Apr. 25, 2024 (JP) 2024-071393

(51) Int. Cl. H01B 11/02; H01B 3/44; H01B 7/295

(52) U.S. Cl. CPC H01B 11/02; H01B 3/441; H01B 7/295

(57) ABSTRACT

A communication cable includes: an electric wire bundle including a plurality of insulated electric wires, each having an electric conductor and a covering layer covering the electric conductor; a sheath layer covering an outer periphery of the electric wire bundle; and an intermediate layer that is interposed between the electric wire bundle and the sheath layer, and covers the outer periphery of the electric wire bundle. The intermediate layer is in close contact with a covering layer of each insulated electric wire, and the sheath layer has a solid structure in which the sheath layer is arranged so as to be in close contact with the intermediate layer. A melting point of a base resin constituting the intermediate layer is 20° C. or more lower than a melting point of base resins constituting the covering layer and the sheath layer.

### CROSS REFERENCE TO RELATED APPLICATION

The present application is based on, and claims priority from the prior Japanese Patent Application No. 2024-071393, filed on Apr. 25, 2024, the entire contents of which are incorporated herein by reference.

### TECHNICAL FIELD

The present disclosure relates to a communication cable.

### BACKGROUND

Conventionally, communication cables have been developed which enable implementation of advanced electrical information communications required for automatic driving of vehicles. JP 2021-136105 A discloses a communication wire which includes a signal wire with a plurality of insulated electric wires, each having an electric conductor and an insulation sheath covering an outer periphery of the electric conductor, and a solid sheath covering an outer periphery of the signal wire. A material constituting the sheath has a melt flow rate of 0.25 g/10 min or more measured at 200° C. with a load of 2.16 kg.

JP 2017-188431 A discloses a communication wire having a twisted-pair wire formed by twisting a pair of insulated electric wires which are formed of conductors having a tensile strength of 400 MPa or more, and insulation sheaths covering the outer periphery of the electric conductors. A characteristic impedance of the communication wire is in a range of 100±10Ω, and a difference in the capacitance of the insulated electric wires forming the twisted-pair wire is 25 pF/m or less. Further, the communication wire has a sheath which is made of an insulating material and covers an outer periphery of the twisted-pair wire. Air gaps are present between the sheath and the insulated electric wires forming the twisted-pair wire.

The communication wire disclosed in JP 2021-136105 A has a solid structure in which substantially no air gap is formed between the signal wire and the sheath, and a material forming the sheath is in close contact with a surface of each insulated electric wire forming the signal wire. Meanwhile, the communication wire disclosed in JP 2017-188431 A has a tube-structure in which air gaps are present between the sheath and each insulated electric wire.

### SUMMARY OF THE INVENTION

As described above, JP 2021-136105 A discloses that a material having a melt flow rate of 0.25 g/10 min or more is used as the material constituting the sheath. However, even if this kind of material is used as the material constituting the sheath, it may be difficult to peel off the sheath, because the sheath and an insulation sheath of each insulated electric wire are fused when the sheath is extrusion molded.

Meanwhile, since the communication wire disclosed in JP 2017-188431 A has a tube-structure, peeling properties of the sheath are excellent. However, in the communication wire, the insulated electric wires are not restrained by the sheath. Therefore, a structure of the twisted-pair wire tends to change, such as a collapse in a twist pitch of the twisted-pair wire and a change in a distance between the wires. Therefore, the communication wire disclosed in JP 2017-188431 A may affect communication characteristics due to attachment to an exterior material, or bending when the communication wire is mounted in a vehicle.

The present disclosure has been made in view of the problems in the past. An object of the present disclosure is to provide a communication cable which has stable communication characteristics even when the communication cable is mounted in a vehicle, and which has a sheath layer excellent in peeling properties.

A communication cable according to an aspect of the present disclosure includes: an electric wire bundle including a plurality of insulated electric wires, each having an electric conductor and a covering layer covering the electric conductor; a sheath layer covering an outer periphery of the electric wire bundle; and an intermediate layer that is interposed between the electric wire bundle and the sheath layer and covers the outer periphery of the electric wire bundle. The intermediate layer is in close contact with a covering layer of each insulated electric wire, and the sheath layer has a solid structure in which the sheath layer is arranged so as to be in close contact with the intermediate layer. A melting point of a base resin constituting the intermediate layer is 20° C. or more lower than a melting point of base resins constituting the covering layer and the sheath layer. The base resin constituting the intermediate layer is at least one of a polyethylene resin or a polyethylene copolymer, and the base resins constituting the covering layer and the sheath layer are polypropylene resins.

According to the present disclosure, it is possible to provide a communication cable which has stable communication characteristics even when the communication cable is mounted in a vehicle, and which has a sheath layer excellent in peeling properties.

### BRIEF DESCRIPTION OF DRAWINGS

FIG. 1 is a cross-sectional view illustrating an example of a communication cable according to the present embodiment.

FIG. 2 is a cross-sectional view illustrating an example of the communication cable according to the present embodiment.

### DETAILED DESCRIPTION OF THE INVENTION

A communication cable according to the present embodiment will be described in detail below with reference to the drawings. The dimensional ratios of the drawings are exaggerated for convenience of explanation and may differ from the actual ratios.

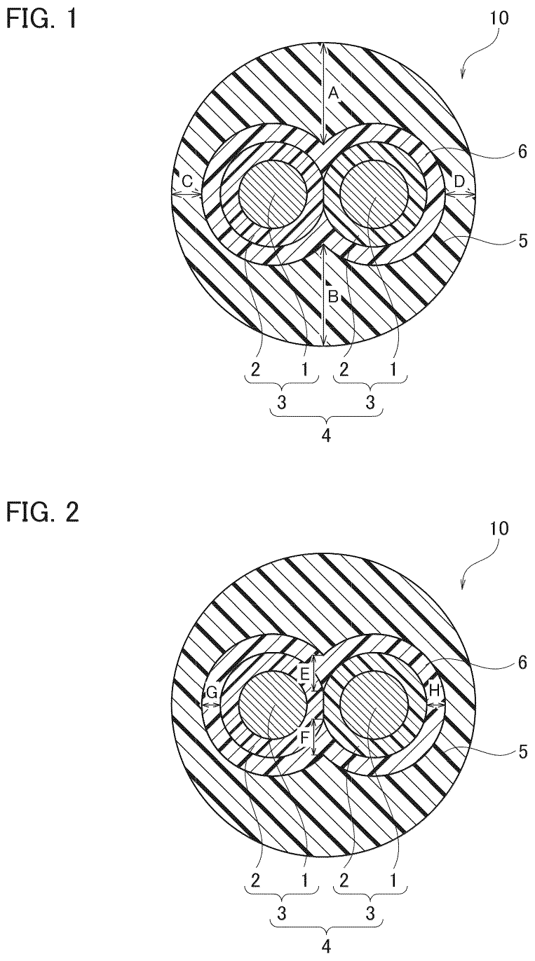

As illustrated in FIG. 1, a communication cable 10 according to the present embodiment includes an electric wire bundle 4 composed of a plurality of insulated electric wires 3, each having an electric conductor 1 and a covering layer 2 covering an outer periphery of the electric conductor 1, and a sheath layer 5 covering an outer periphery of the electric wire bundle 4. In the communication cable 10 illustrated in FIG. 1, the electric wire bundle 4 includes two insulated electric wires 3. The communication cable 10 further include an intermediate layer 6 which is interposed between the electric wire bundle 4 and the sheath layer 5 and covers the outer periphery of the electric wire bundle 4.

The electric conductor 1 may be constituted by only one element wire, or may be an aggregated twisted wire constituted by bundling a plurality of element wires. Further, the electric conductor 1 may be constituted by only one twisted wire, or may be a composite twisted wire constituted by bundling a plurality of aggregated twisted wires. Still further, the electric conductor 1 may be a compressed conductor or an uncompressed conductor. A material constituting the electric conductor 1 is not particularly limited, but the material is preferably at least one electroconductive metal material selected from the group consisting of copper, a copper alloy, aluminum, and an aluminum alloy.

An outer diameter of the electric conductor 1 is not particularly limited, but the outer diameter is preferably 0.435 mm or more, and more preferably 0.440 mm or more. Due to the outer diameter of the electric conductor 1 having the above values, it is possible to reduce the resistance of the electric conductor 1. Further, although the outer diameter of the electric conductor 1 is not particularly limited, the outer diameter is preferably 0.465 mm or less, and more preferably 0.460 mm or less.

The thickness of the covering layer 2 is not particularly limited, but the thickness is preferably 0.15 mm or more, and more preferably 0.18 mm or more. Due to the thickness of the covering layer 2 having the above values, it is possible to effectively protect the electric conductor 1. Further, although the thickness of the covering layer 2 is not particularly limited, the thickness is preferably 0.32 mm or less.

The covering layer 2 covers the entire outer periphery of the electric conductor 1. In the communication cable 10 illustrated in FIG. 1, the covering layer 2 is in close contact with the entire surface of the electric conductor 1.

The electric wire bundle 4 has the plurality of insulated electric wires 3, and each of the insulated electric wires 3 has the electric conductor 1 and the covering layer 2, and constitutes a signal wire. The plurality of insulated electric wires 3 may be twisted together to form a twisted wire. Further, the plurality of insulated electric wires 3 may be parallel to each other without being twisted. However, if the plurality of insulated electric wires 3 are used as a twisted wire, it is less likely that the insulated electric wires 3 are affected by external noise and that the insulated electric wires 3 affect the outside with noise, than when the insulated electric wires 3 are parallel to each other. Therefore, it is preferable that the plurality of insulated electric wires 3 in the electric wire bundle 4 are used as a twisted wire.

The sheath layer 5 covers the outer periphery of the electric wire bundle 4, and therefore the sheath layer 5 has a function of protecting the insulated electric wires 3, and further a function of stabilizing relative positions of the plurality of insulated electric wires 3 in the electric wire bundle 4. The sheath layer 5 has a solid structure in which there is substantially no air gap between the sheath layer 5 and the intermediate layer 6, and a material forming the sheath layer 5 is in close contact with a surface of the intermediate layer 6. As will be described later, the intermediate layer 6 covers the entire outer periphery of the electric wire bundle 4, and further is in close contact with the entire surface of the electric wire bundle 4. Therefore, the sheath layer 5 having the solid structure and the intermediate layer 6 can stabilize the relative positions of the plurality of insulated electric wires 3. It is preferable that there is no air gap between the intermediate layer 6 and the sheath layer 5, but the slight amount of air gaps may be present therebetween, when the relative positions of the plurality of insulated electric wires 3 are substantially unchanged.

In the communication cable 10, the intermediate layer 6 is interposed between the electric wire bundle 4 and the sheath layer 5, and further covers the entire surface of the electric wire bundle 4. The presence of this kind of intermediate layer 6 can facilitate peeling of the sheath layer 5.

Resin compositions constituting the covering layer 2 of each insulated electric wire 3 and the sheath layer 5 contain base resins as a main component. Similarly, a resin composition constituting the intermediate layer 6 contains a base resin as a main component. In the present specification, the amount of the base resin contained in a resin composition constituting each layer is 50% by mass or more.

Base resins constituting the covering layer 2 and the sheath layer 5 may be the same. However, the base resins constituting the covering layer 2 and the sheath layer 5 and a base resin constituting the intermediate layer 6 are different from each other. Due to the base resin constituting the covering layer 2 being different from the base resin constituting the intermediate layer 6, fusion of the resins is less likely to occur. Similarly, due to the base resin constituting the sheath layer 5 being different from the base resin constituting the intermediate layer 6, fusion of the resins is less likely to occur. Therefore, when a load is applied to the sheath layer 5 in order to peel off the sheath layer 5, peeling occurs between the covering layer 2 and the intermediate layer 6 and/or between the sheath layer 5 and the intermediate layer 6, and air gaps are likely to be formed. As a result, it is possible to easily separate the sheath layer 5 from the covering layer 2 and/or the intermediate layer 6.

Further, a melting point of the base resin constituting the intermediate layer 6 is preferably 20° C. or more lower than a melting point of the base resins constituting the covering layer 2 and the sheath layer 5. As will be described later, the sheath layer 5 and the intermediate layer 6 can be formed on the outer periphery of the electric wire bundle 4 by extrusion molding a resin composition of the sheath layer 5, and a resin composition of the intermediate layer 6, on the outer periphery of the electric wire bundle 4. At this time, since the melting point of the base resin constituting the intermediate layer 6 is 20° C. or more lower than the melting point of the base resins constituting the covering layer 2 and the sheath layer 5, the melting point of the covering layer 2 is higher than the melting point of the intermediate layer 6. Therefore, it is less likely that the covering layer 2 is molten due to the heat of the intermediate layer 6 generated when extrusion molding is performed. As a result, since it is less likely that the thickness of the covering layer 2 is partially reduced, the electric conductor 1 can be effectively protected by the covering layer 2.

The base resins constituting the covering layer 2 and the sheath layer 5 are preferably polypropylene resins. Further, the base resin constituting the intermediate layer 6 is preferably at least one of a polyethylene resin or a polyethylene copolymer. The polypropylene resin, polyethylene resin, and polyethylene copolymer are excellent in terms of instantaneous heat resistance due to having relatively high melting points. Therefore, the covering layer 2, and the sheath layer 5 and intermediate layer 6 can be easily formed by means of an extrusion molding method.

Examples of the polypropylene resin include homopolypropylene (homo PP), random polypropylene (random PP), block polypropylene (block PP), and copolymers with other olefins that can be copolymerized with propylene. Examples of other olefins that can be copolymerized with propylene include α-olefins such as ethylene, 1-butene, isobutylene, 1-pentene, 3-methyl-1-butene, 1-hexene, 3,4-dimethyl-1-butene, 1-heptene, and 3-methyl-1-hexene. Examples of the polyethylene resin include a high-density polyethylene resin (HDPE), a low-density polyethylene resin (LDPE), and a linear low-density polyethylene resin (LLDPE). Examples of the polyethylene copolymer include an ethylene-vinyl acetate copolymer, an ethylene-propylene copolymer, an ethylene-propylene-butene-1 copolymer, an ethylene-butene-1 copolymer, an ethylene-hexene-1 copolymer, an ethylene-4-methylpentene-1 copolymer, an ethylene-octene-1 copolymer, and mixtures thereof.

The base resins constituting the covering layer 2 and the sheath layer 5 may be polypropylene resins with a melting point of 160° C. or higher. Further, the base resin constituting the intermediate layer 6 may be at least one of a polyethylene resin or a polyethylene copolymer, and the polyethylene resin and the polyethylene copolymer have a melting point of 140° C. or lower. Even if this kind of configuration is adopted, it is possible to enhance instantaneous heat resistance. Therefore, the covering layer 2, and the sheath layer 5 and intermediate layer 6 can be easily formed by means of an extrusion molding method.

In order to enhance the flexibility of the communication cable 10, the covering layer 2 and the sheath layer 5 may contain flexible resins in addition to the base resins. As the flexible resins, it is possible to use chlorinated polyolefin such as chlorinated polyethylene resins, acrylic rubbers such as nitrile rubbers (NBR), or one or more of olefinic thermoplastic elastomers or one or more of styrenic thermoplastic elastomers described in the following paragraphs. The flexible resins may or may not be modified with a maleic acid or the like.

The olefinic thermoplastic elastomer includes a hard segment made of an olefinic resin and a soft segment made of a rubber. A typical example of the olefinic thermoplastic elastomer is a polymer alloy in which the soft segment is finely dispersed as a domain in a matrix of the hard segment. A copolymer of the hard segment and the soft segment can also be used as the olefinic thermoplastic elastomer. As the olefinic resin, it is possible to use a polyethylene resin, a polypropylene resin, and the like, for example. As the rubber, it is possible to use a natural rubber (NR), an isoprene rubber (IR), a butadiene rubber (BR), a styrene-butadiene copolymer rubber (SBR), an acrylonitrile-butadiene copolymer rubber (NBR), a chloroprene rubber (CR), a butyl rubber (IR), an ethylene-propylene rubber (EPM), an ethylene-propylene-diene rubber (EPDM), and the like, for example. One of these rubbers may be used alone, or a mixture of a plurality of kinds of rubbers may be used.

An example of the styrenic thermoplastic elastomer is a block copolymer or a random copolymer having a hard segment made of an aromatic vinyl polymer and a soft segment made of a conjugated diene polymer. Monomers forming the aromatic vinyl polymer may be α-alkyl-substituted styrenes such as styrene, α-methylstyrene, α-ethylstyrene, and α-methyl-p-methylstyrene, and aromatic alkyl-substituted styrenes such as o-methylstyrene, m-methylstyrene, p-methylstyrene, 2,4-dimethylstyrene, ethylstyrene, 2,4,6-trimethylstyrene, o-t-butylstyrene, p-t-butylstyrene, and p-cyclohexylstyrene. The conjugated diene polymer may be a copolymer of at least one of butadiene or isoprene, and a substance formed by hydrogenating a part of the copolymer.

The styrenic thermoplastic elastomer may be at least one block copolymer selected from the group consisting of polystyrene-polybutadiene-polystyrene (SBS), polystyrene-polyisoprene-polystyrene (SIS), polystyrene-polyisobutylene-polystyrene (SIBS), a styrene-ethylene-butylene-styrene block copolymer (SEBS), polystyrene-poly(ethylene-butylene)-crystalline polyolefin (SEBC), and polystyrene-poly(ethylene-propylene)-polystyrene (SEPS).

The sheath layer 5 can contain 0 to 49 parts by mass of a flexible resin, relative to 51 to 100 parts by mass of a base resin. That is, the amount of the flexible resin may be 0 parts by mass or more and 49 parts by mass or less, relative to 100 parts by mass of the total of the base resin and the flexible resin. Due to the amount of the flexible resin being 49 parts by mass or less, the wear resistance can be maintained, while enhancing the flexibility of the resin composition.

As illustrated in FIGS. 1 and 2, when there are two insulated electric wires 3 in the electric wire bundle 4, the thickness of the intermediate layer 6 is preferably 20 to 80% of the thickness of the sheath layer 5. Due to the thickness of the intermediate layer 6 being 20% or more of the thickness of the sheath layer 5, as will be described later, melting of a covering layer 2 of each insulated electric wire 3 is suppressed, when the intermediate layer 6 and the sheath layer 5 are extrusion molded. Therefore, it is possible to prevent a partial reduction in the thickness of the covering layer 2. Further, due to the thickness of the intermediate layer 6 being 80% or less of the thickness of the sheath layer 5, it is possible to suppress a deterioration in the flame retardancy of the communication cable 10. A value of the thickness of the sheath layer 5 is the average value of the thicknesses of four portions, which are thicknesses A and B of two portions that are perpendicular to a center line passing through the center of two electric conductors 1 and are along a joining surface of the two insulated electric wires 3, and thicknesses C and D of two portions which are along the center line passing through the center of the two conductors, as illustrated in FIG. 1. Further, a value of the thickness of the intermediate layer 6 is the average value of the thicknesses of four portions, which are thicknesses E and F of two portions that are perpendicular to a center line passing through the center of two conductors 1 and are along a joining surface of the two insulated electric wires 3, and thicknesses G and H of two portions which are along the center line passing through the center of the two conductors 1, as illustrated in FIG. 2.

In addition to the base resin and the flexible resin, an appropriate amount of various additives can be added to resin compositions forming the covering layer 2, and the sheath layer 5 and intermediate layer 6, to the extent that effects of the present embodiment are not inhibited. Examples of the additives include antioxidants, copper inhibitors, flame retardants, processing aids, cross-linking agents, metal deactivators, anti-aging agents, fillers, reinforcing agents, ultraviolet absorbers, stabilizers, plasticizers, pigments, dyes, colorants, antistatic agents, foaming agents, and the like.

When the sheath layer 5 has a solid structure, it is necessary to keep the dielectric constant of the insulated electric wires 3 low. Therefore, it is preferable that the amount of additives added to the base resin of the covering layer 2 is minimized as much as possible. However, when copper or a copper alloy is used for the electric conductor 1, due to the contact between the covering layer 2 and the electric conductor 1, oxidation degradation of the covering layer 2, referred to as copper damage, may occur. Therefore, it is preferable to add an antioxidant and a copper inhibitor to the base resin forming the covering layer 2, to the extent that communication characteristics do not deteriorate.

The antioxidant suppresses oxidation of the covering layer 2. As the antioxidant, it is possible to use known antioxidants used for thermoplastic resins and the like, including radical chain inhibitors such as phenol-based antioxidants, hindered phenol-based antioxidants, and amine-based antioxidants; peroxide decomposers such as phosphorous-based antioxidants and sulfur-based antioxidants, and metal deactivators such as hydrazine-based antioxidants and amine-based antioxidants. One of the antioxidants may be used alone, or a mixture of a plurality of antioxidants may be used.

The amount of an antioxidant may be adjusted in consideration of an antioxidant effect and the influence on communication characteristics. The amount of an antioxidant in a resin composition constituting the covering layer 2 is preferably in a range from 0.1 to 5.0 parts by mass, relative to 100 parts mass of a polypropylene resin. Due to the amount of the antioxidant being 0.1 parts by mass or more, it is possible to enhance the heat resistance. Further, due to the amount of the antioxidant being 5.0 parts by mass or less, it is possible to suppress the influence on communication characteristics.

A copper inhibitor suppresses oxidation degradation of the covering layer 2, referred to as a copper damage, which is caused by contact between the covering layer 2 and the electric conductor 1 (copper or copper alloy). As the copper inhibitor, a salicyl-based copper inhibitor or a hydrazine-based copper inhibitor is used, for example. The amount of a copper inhibitor in a resin composition constituting the covering layer 2 is preferably in a range from 0.1 to 3.0 parts by mass, relative to 100 parts mass of a polypropylene resin. Due to the amount of the copper inhibitor being 0.1 parts by mass or more, it is possible to effectively impart a copper damage prevention effect. Further, due to the amount of the copper inhibitor being 3.0 parts by mass or less, it is possible to suppress the influence on communication characteristics.

It is preferable that a flame retardant is added to a resin composition constituting the sheath layer 5 in order to ensure the flame retardancy required as electric wire characteristics. In addition, it is preferable that an antioxidant or the like is added to the resin composition constituting the sheath layer 5 in the same manner as the covering layer 2, to the extent that communication characteristics are not inhibited.

The flame retardant enhances the flame retardancy of the sheath layer 5. By enhancing the flame retardancy of the sheath layer 5, even if a fire occurs in a vehicle, the spread of the fire can be suppressed in the sheath layer 5.

The flame retardant may be at least either an organic flame retardant or an inorganic flame retardant, for example. As the organic flame retardant, it is possible to use halogen-based flame retardants such as bromine-based flame retardants and chlorine-based flame retardants, and phosphorus-based flame retardants such as phosphate esters, condensed phosphate esters, cyclic phosphorus compounds, and red phosphorus, for example. As the inorganic flame retardant, it is possible to use at least one metal hydroxide selected from the group consisting of aluminum hydroxide, magnesium hydroxide, and calcium hydroxide. One of the flame retardants may be used alone, or a mixture of a plurality of flame retardants may be used. The flame retardant may include an organic flame retardant and an inorganic flame retardant, for example.

It is preferable that the resin composition contains at least a halogen-based flame retardant as the organic flame retardant. The halogen-based flame retardant can trap hydroxyl radicals which promote the combustion of a base resin constituting the sheath layer 5, and suppress the combustion of the base resin. The halogen-based flame retardant may be a compound in which at least one or more halogens are substituted in an organic compound. Examples of the halogen-based flame retardant include fluorine-based flame retardants, chlorine-based flame retardants, bromine-based flame retardants, and iodine-based flame retardants. The halogen-based flame retardant is preferably a bromine-based flame retardant.

It is preferable that the resin composition contains at least metal hydroxide as the inorganic flame retardant. Metal hydroxide is usable for a general-purpose as a flame retardant and a cost thereof is relatively lower than that of a bromine-based flame retardant. Further, since the dielectric constant of metal hydroxide is higher than that of a general polyolefin-based resin, metal hydroxide acts as a dielectric constant adjuster. Therefore, the sheath layer 5 of the present embodiment preferably contains metal hydroxide. As the metal hydroxide, it is possible to use one or more metal compounds having hydroxyl groups or crystalline water, such as magnesium hydroxide (Mg(OH)₂), aluminum hydroxide (Al(OH)₃), calcium hydroxide (Ca(OH)₂), basic magnesium carbonate (mMgCO₃·Mg(OH)₂·nH₂O), hydrated aluminum silicate (aluminum silicate hydrate, Al₂O₃·3SiO₂·nH₂O), and hydrated magnesium silicate (magnesium silicate pentahydrate, Mg₂Si₃O₈·5H₂O). Among these, magnesium hydroxide is particularly preferable as the metal hydroxide.

The amount of a flame retardant in the resin composition constituting the sheath layer 5 is preferably in a range from 60 to 150 parts by mass, relative to 100 parts mass of the total of the polypropylene resin and the flexible resin. Due to the amount of the flame retardant being 60 parts by mass or more, it is possible to enhance the flame retardancy of the sheath layer 5. In addition, due to the amount of the flame retardant being 150 parts by mass or less, it is possible to avoid using more flame retardants than required, while maintaining mechanical characteristics of the sheath layer 5. This can reduce the manufacturing cost of the sheath layer 5.

As an antioxidant contained in the sheath layer 5, it is possible to use the antioxidant used for the covering layer 2, for example.

The amount of an antioxidant added may be adjusted in consideration of an antioxidant effect and the influence on communication characteristics. The amount of an antioxidant in the resin composition constituting the sheath layer 5 is preferably in a range from 0.1 to 5.0 parts by mass, relative to 100 parts mass of the total of the polypropylene resin and the flexible resin. Due to the amount of the antioxidant being 0.1 parts by mass or more, it is possible to enhance the heat resistance. Further, due to the amount of the antioxidant being 5.0 parts by mass or less, it is possible to suppress the influence on communication characteristics.

The communication cable 10 of the present embodiment can be fabricated by means of the following method. First, resin compositions constituting the covering layer 2, and the sheath layer 5 and intermediate layer 6 are prepared. These resin compositions are fabricated by melt-kneading raw materials of the resin compositions described above, and a known method can be used therefor. The resin compositions can be obtained by pre-blending raw materials with a high-speed mixer such as a Henschel mixer and then kneading the raw materials with a known kneader such as a Banbury mixer, a kneader, or a roll mill.

Next, the electric conductor 1 is covered with the covering layer 2 to obtain each insulated electric wire 3. A method for covering the electric conductor 1 with the covering layer 2 is not particularly limited, but a general extrusion molding method can be used, for example. As an extruder used for the extrusion molding method, a single-screw extruder or a twin-screw extruder is used, and an extruder with a screw, a breaker plate, a crosshead, a distributor, a nipple, or a die can be used, for example.

Next, a plurality of obtained insulated electric wires 3 are bundled together to obtain the electric wire bundle 4. At this time, the plurality of the insulated electric wires 3 may be twisted together to form a twisted wire.

Then, the sheath layer 5 and the intermediate layer 6 are formed in the periphery of the electric wire bundle 4. Although a method for forming the sheath layer 5 and the intermediate layer 6 is not particularly limited, the sheath layer 5 and the intermediate layer 6 can be formed by twin-screw extrusion molding a resin composition of the sheath layer 5 and a resin composition of the intermediate layer 6. At this time, extrusion molding conditions are adjusted such that the sheath layer 5 has a solid structure.

When the sheath layer 5 and the intermediate layer 6 are formed by means of twin-screw extrusion molding, the resin composition of the sheath layer 5 and the resin composition of the intermediate layer 6 are simultaneously extruded. Therefore, the intermediate layer 6 is in close contact with the sheath layer 5. Therefore, when the sheath layer 5 is peeled off, the intermediate layer 6 can be peeled off together with the sheath layer 5. This enhances the work efficiency.

The communication cable 10 of the present embodiment can be obtained by means of this kind of method.

In this way, the communication cable 10 of the present embodiment includes the electric wire bundle 4 including the plurality of insulated electric wires 3, each having the electric conductor 1 and the covering layer 2 covering the electric conductor, the sheath layer 5 covering the outer periphery of the electric wire bundle, and the intermediate layer 6 which is interposed between the electric wire bundle 4 and the sheath layer 5 and covers the outer periphery of the electric wire bundle. The intermediate layer 6 is in close contact with the covering layer 2 of each insulated electric wire 3, and the sheath layer 5 has a solid structure in which the sheath layer 5 is arranged so as to be in close contact with the intermediate layer 6. A melting point of a base resin constituting the intermediate layer 6 is 20° C. or more lower than a melting point of base resins constituting the covering layer 2 and the sheath layer 5. The base resin constituting the intermediate layer 6 is at least one of a polyethylene resin or a polyethylene copolymer, and the base resins constituting the covering layer 2 and the sheath layer 5 are polypropylene resins.

Since the sheath layer 5 of the communication cable 10 has a solid structure, relative positions of the plurality of insulated electric wires 3 can be stabilized. Therefore, communication characteristics can be stabilized even when the communication cable 10 is mounted on a vehicle. Further, in the communication cable 10, the intermediate layer 6 is disposed between the covering layer 2 of each insulated electric wires 3 and the sheath layer 5. Therefore, since the sheath layer 5 is easily detached, the sheath layer 5 can be easily peeled off.

In the communication cable 10, the electric wire bundle 4 may be a twisted wire formed by twisting the plurality of insulated electric wires 3. It is less likely that the twisted wire is affected by external noise and that the twisted wire affects the outside with noise. Therefore, due to the electric wire bundle 4 being the twisted wire, function of the communication cable 10 can be further enhanced.

The base resin constituting the intermediate layer 6 in the communication cable 10 may be at least one of a polyethylene resin or a polyethylene copolymer with a melting point of 140° C. or lower. The base resins constituting the covering layer 2 and the sheath layer 5 may be polypropylene resins with a melting point of 160° C. or higher. With this kind of configuration, it is less likely that the covering layer 2 is molten due to the heat of the intermediate layer 6 generated when extrusion molding is performed. As a result, it is less likely that the thickness of the covering layer 2 is partially reduced. Therefore, the electric conductor 1 can be effectively protected by the covering layer 2.

The covering layer 2 of the communication cable 10 may contain 0.1 to 5.0 parts by mass of an antioxidant, and 0.1 to 3.0 parts by mass of a copper inhibitor, relative to 100 parts by mass of a polypropylene resin. With this kind of configuration, an antioxidant effect and a copper damage prevention effect can be effectively imparted to the covering layer 2.

The sheath layer 5 of the communication cable 10 may contain 0 to 49 parts by mass of a flexible resin, relative to 51 to 100 parts by mass of a polypropylene resin. Further, the sheath layer 5 may contain 0.1 to 5.0 parts by mass of an antioxidant and 60 to 150 parts by mass of a flame retardant, relative to 100 parts mass of the total of the polypropylene resin and the flexible resin. With this kind of configuration, it is possible to effectively impart an antioxidant effect and a flame retardant effect, while imparting the flexibility to the sheath layer 5.

In the communication cable 10, when there are two insulated electric wires 3 in the electric wire bundle 4, the thickness of the intermediate layer 6 may be 20 to 80% of the thickness of the sheath layer 5. With this kind of configuration, it is less likely that the covering layer 2 is molten due to the heat of the intermediate layer 6 generated when extrusion molding is performed. As a result, it is less likely that the thickness of the covering layer 2 is partially reduced. Therefore, the electric conductor 1 can be effectively protected by the covering layer 2.

The present embodiment will be described in more detail below using examples, a comparative example, and reference examples, but the present embodiment is not limited to these examples.

### [Fabrication of Test Samples]

In order to fabricate test samples of Examples 1 to 4, Comparative Example 1, and Reference Examples 1 and 2, the following materials were prepared as raw materials for resin compositions of the covering layer of each insulated electric wire, the sheath layer, and the intermediate layer.
Polypropylene resin (PP): Prime Polypro (registered trademark) E-150GK, manufactured by Prime Polymer Co., Ltd., melting point 162° C.
Polyethylene resin (PE): Novatec (registered trademark) HE122R, high-density polyethylene resin, manufactured by Japan Polypropylene Corporation, melting point 128° C.
Ethylene-vinyl acetate copolymer (EVA): Evaflex (registered trademark) P1007, manufactured by DOW-MITSUI POLYCHEMICALS CO., LTD., melting point 94° C.
Styrene-ethylene-butylene-styrene block copolymer (SEBS): Septon (registered trademark) 8007L, manufactured by Kuraray Co., Ltd.
Phenol-based antioxidant: ADKSTAB (registered trademark) AO-60, Pentaerythritol tetrakis[3-(3,5-di-tert-butyl-4-hydroxyphenyl)propionate], manufactured by ADEKA Corporation
Copper inhibitor: ADKSTAB (registered trademark) CDA-10, N,N′-Bis[3-(3,5-di-tert-butyl-4-hydroxyphenyl)propionyl]hydrazine, manufactured by ADEKA Corporation
Flame retardant: magnesium hydroxide, manufactured by Konoshima Chemical Co., Ltd.

### Example 1

First, each raw material was weighed according to the blending amounts shown in Table 1, and then the raw materials were melt-kneaded to prepare resin compositions constituting the covering layer, and the intermediate layer and sheath layer.

Next, a copper alloy conductor having a twisted wire outer diameter φ of 0.45 mm was prepared. Then, the resin composition of the covering layer was extrusion molded on the outer periphery of the electric conductor to form a covering layer of 0.2 mm thickness. In this way, an insulated electric wire in which the entire outer periphery of the electric conductor was covered with the covering layer was obtained. Then, two insulated electric wires were prepared, and they were twisted to obtain an electric wire bundle.

Next, the resin composition of the intermediate layer and the resin composition of the sheath layer were twin-screw extrusion molded on the outer periphery of the electric wire bundle to form the intermediate layer and the sheath layer. During extrusion molding, the thickness of the sheath layer was adjusted to be 0.75 mm, the thickness of the intermediate layer was adjusted to have values shown in Table 1, and further, the sheath layer was adjusted to have a solid structure. In this way, a test sample of the present example was obtained in which the entire outer periphery of the electric wire bundle was covered with the intermediate layer and the sheath layer. The outer diameter φ of the obtained test sample was 3.2 mm.

As illustrated in FIG. 1, a value of the thickness of the sheath layer was set to be the average value of the thicknesses of four portions, which were the thicknesses A and B of two portions that were perpendicular to a center line passing through the center of two conductors and were along a joining surface of two insulated electric wires, and the thicknesses C and D of two portions that were along the center line passing through the center of the two conductors. Further, as illustrated in FIG. 2, a value of the thickness of the intermediate layer was set to be the average value of the thicknesses of four portions, which were the thicknesses E and F of two portions that were perpendicular to a center line passing through the center of two conductors and were along a joining surface of two insulated electric wires, and the thicknesses G and H of two portions that were along the center line passing through the center of the two conductors.

### Examples 2 to 4

Test samples of each example were obtained by the same method as in Example 1, except that raw materials and blending amounts of the covering layer, the intermediate layer, and the sheath layer were changed as shown in Table 1.

### Comparative Example 1

A test sample of the present example was obtained by the same method as in Example 1, except that raw materials and blending amounts of the covering layer and the sheath layer were changed as shown in Table 2. In Comparative Example 1, no intermediate layer was formed, and the sheath layer had a solid structure in which the sheath layer was arranged so as to be in close contact with a covering layer of each insulated electric wire.

### Reference Examples 1 and 2

Test samples of each example were obtained by the same method as in Example 1, except that raw materials and blending amounts of the covering layer, the intermediate layer, and the sheath layer were changed as shown in Table 2. During extrusion molding, the thickness of the sheath layer was adjusted to be 0.75 mm, the thickness of the intermediate layer was adjusted to have values shown in Table 2, and further the sheath layer was adjusted to have a solid structure.

TABLE 1

| | Example 1 | | | Example 2 | | | Example 3 | | | Example 4 | | |
|---|---|---|---|---|---|---|---|---|---|---|---|---|
| | | Inter- | | | Inter- | | | Inter- | | | Inter- | |
| | Covering | mediate | Sheath | Covering | mediate | Sheath | Covering | mediate | Sheath | Covering | mediate | Sheath |
| | layer | layer | layer | layer | layer | layer | layer | layer | layer | layer | layer | layer |
| PP | 100 | — | 51 | 100 | — | 100 | 100 | — | 70 | 100 | — | 70 |
| (parts by mass) | | | | | | | | | | | | |
| PE | — | 100 | — | — | 100 | — | — | — | — | — | 100 | — |
| (parts by mass) | | | | | | | | | | | | |
| EVA | — | — | — | — | — | — | — | 100 | — | — | — | — |
| (parts by mass) | | | | | | | | | | | | |
| SEBS | — | — | 49 | — | — | 0 | — | — | 30 | — | — | 30 |
| (parts by mass) | | | | | | | | | | | | |
| Antioxidant | 0.1 | — | 0.1 | 5 | — | 5 | 0.1 | — | 0.1 | 0.1 | — | 0.1 |
| (parts by mass) | | | | | | | | | | | | |
| Copper inhibitor | 0.1 | — | — | 3 | — | 8 | 0.1 | — | — | 0.1 | — | — |
| (parts by mass) | | | | | | | | | | | | |
| Flame retardant | — | — | 60 | — | — | 150 | — | — | 100 | — | — | 100 |
| (parts by mass) | | | | | | | | | | | | |
| Thickness of | 0.15 mm | | | 0.15 mm | | | 0.15 mm | | | 0.6 mm | | |
| intermediate layer | | | | | | | | | | | | |
| Adhesion test | ∘ | | | ∘ | | | ∘ | | | ∘ | | |
| Structural test | ∘ | | | ∘ | | | ∘ | | | ∘ | | |
| Flame | ∘ | | | ∘ | | | ∘ | | | ∘ | | |
| retardant test | | | | | | | | | | | | |

TABLE 2

| | Comparative Example 1 | | | Reference Example 1 | | | Reference Example 2 | | |
|---|---|---|---|---|---|---|---|---|---|
| | Covering | Intermediate | Sheath | Covering | Intermediate | Sheath | Covering | Intermediate | Sheath |
| | layer | layer | layer | layer | layer | layer | layer | layer | layer |
| PP | 100 | — | 70 | 100 | — | 70 | 100 | — | 70 |
| (parts by mass) | | | | | | | | | |
| PE | — | No | — | — | 100 | — | — | 100 | — |
| (parts by mass) | | | | | | | | | |
| EVA | — | No | — | — | — | — | — | — | — |
| (parts by mass) | | | | | | | | | |
| SEBS | — | — | 30 | — | — | 30 | — | — | 30 |
| (parts by mass) | | | | | | | | | |
| Antioxidant | 0.1 | — | 0.1 | 1 | — | 1 | 1 | — | 1 |
| (parts by mass) | | | | | | | | | |
| Copper inhibitor | 0.1 | — | — | 1 | — | — | 1 | — | — |
| (parts by mass) | | | | | | | | | |
| Flame retardant | — | — | 60 | — | — | 100 | — | — | 100 |
| (parts by mass) | | | | | | | | | |
| Thickness of | 0 mm | | | 0.10 mm | | | 0.65 mm | | |
| intermediate layer | | | | | | | | | |
| Adhesion test | x | | | ∘ | | | ∘ | | |
| Structural test | x | | | x | | | ∘ | | |
| Flame | ∘ | | | ∘ | | | x | | |
| retardant test | | | | | | | | | |

### [Evaluation]

The test samples of each example obtained as described above were subjected to adhesion tests, structural tests, and flame retardant tests.

### (Adhesion Test)

A load required to peel off a sheath layer of 20 mm in length at an end of a test sample of each example was measured. As a result of the measurement, when the load required for peeling was less than 50 N, it was evaluated as “∘”, and if the load required for peeling was 50 N or more, it was evaluated as “x”. Both Tables 1 and 2 show the measurement results.

From Tables 1 and 2, it can be seen that test samples of Examples 1 to 4 had excellent peeling properties, because the load required to peel off a sheath layer was less than 50 N. In other words, in each of the test samples of Examples 1 to 4, a base resin of an intermediate layer was a polyethylene resin or a polyethylene copolymer, base resins of a covering layer and a sheath layer were polypropylene resins, and the difference in melting points thereof was 20° C. or more. Therefore, fusion between a covering layer and an intermediate layer was less likely to occur, and peeling properties became favorable.

In contrast, it can be seen that a test sample of Comparative Example 1 had inferior peeling properties, because the load required to peel off a sheath layer was 50 N or more. In other words, in the test sample of Comparative Example 1, there was no intermediate layer, a covering layer and a sheath layer were in close contact, and base resins of both the covering layer and the sheath layer were polypropylene resins. Therefore, the covering layer and the sheath layer were fused, and peeling properties of the sheath layer deteriorated.

### (Structural Test)

By observing a cross section of a test sample of each example, the thickness of a covering layer of each insulated electric wire was measured. Specifically, the thicknesses of four portions of a covering layer of each insulated electric wire were measured, and the thicknesses of a total of eight portions of two covering layers were measured. When the thicknesses of all of the eight portions were 0.16 mm or more, it was evaluated as “∘”, and if the eight portions had even one portion with the thickness of less than 0.16 mm, it was evaluated as “x”. Both Tables 1 and 2 show the measurement results.

From Tables 1 and 2, it can be seen that in each of test samples of Examples 1 to 4, the thicknesses of all eight portions of a covering layer were 0.16 mm or more. In other words, when a test sample of each example was fabricated, each insulated electric wire having a covering layer with a thickness of 0.2 mm was used, and an intermediate layer and a sheath layer were extrusion molded on the outer periphery of an electric wire bundle formed by twisting two insulated electric wires. If the thickness of the intermediate layer was insufficient, the covering layer was molten when the intermediate layer and the sheath layer were extrusion molded, and the thickness of the covering layer was reduced.

However, in a test sample of Example 1, the thickness of an intermediate layer was 0.15 mm and the thickness of a sheath layer was 0.75 mm. Therefore, the thickness of the intermediate layer was 20% of the thickness of the sheath layer. Since the thickness of the intermediate layer was sufficiently ensured, it can be seen that the melting of the covering layer during extrusion molding was suppressed, and the reduction in the thickness of the covering layer was suppressed.

In test samples of Examples 2 and 3, the thicknesses of intermediate layers were 0.15 mm and the thicknesses of sheath layers were 0.75 mm. Therefore, the thicknesses of the intermediate layers were 20% of the thicknesses of the sheath layers. Further, in a test sample of Example 4, the thickness of an intermediate layer was 0.6 mm, and the thickness of a sheath layer was 0.75 mm. Therefore, the thickness of the intermediate layer was 80% of the thickness of the sheath layer. Therefore, it can be seen that the reduction in the thickness of the covering layers can be suppressed in the test samples.

In contrast, since a test sample of Comparative Example 1 did not have an intermediate layer, a covering layer was molten when a sheath layer was extrusion molded, and the thickness of the covering layer was reduced. Further, in a test sample of Reference Example 1, the thickness of an intermediate layer was 0.10 mm and the thickness of a sheath layer was 0.75 mm. Therefore, the thickness of the intermediate layer was 13% of the thickness of the sheath layer. Since the thickness of the intermediate layer was insufficient, a covering layer was molten during extrusion molding, and the thickness of the covering layer was reduced.

### (Flame Retardant Test)

For a test sample of each example, a wire flame retardancy test according to ISO 19642 was performed. The wire flame retardancy test was performed by arranging a test sample at an angle of 45°. As a result of the wire flame retardancy test, if the fire was extinguished within 70 seconds and a test sample of 50 mm or more remained unburned, it was evaluated as “∘”, and if burning continued for more than 70 seconds or a test sample of less than 50 mm remained unburned, it was evaluated as “x”. Both Tables 1 and 2 show the test results

From Tables 1 and 2, a test sample of Reference Example 2 was inferior in flame retardancy. It is speculated that since the thickness of an intermediate layer was larger than that of test samples of other examples, the flame retardancy deteriorated. In other words, in the test sample of Reference Example 2, the thickness of the intermediate layer was 0.65 mm, and the thickness of a sheath layer was 0.75 mm. Since the thickness of the intermediate layer was 87% of the thickness of the sheath layer, it is speculated that the test sample of Reference Example 2 was inferior in flame retardancy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication cable comprising:
an electric wire bundle comprising a plurality of insulated electric wires, each having an electric conductor and a covering layer covering the electric conductor;
a sheath layer covering an outer periphery of the electric wire bundle; and
an intermediate layer that is interposed between the electric wire bundle and the sheath layer, and covers the outer periphery of the electric wire bundle, wherein
the intermediate layer is in close contact with a covering layer of each insulated electric wire, and the sheath layer has a solid structure in which the sheath layer is arranged so as to be in close contact with the intermediate layer,
a melting point of a base resin constituting the intermediate layer is 20° C. or more lower than a melting point of base resins constituting the covering layer and the sheath layer, and
the base resin constituting the intermediate layer is at least one of a polyethylene resin or a polyethylene copolymer, and the base resins constituting the covering layer and the sheath layer are polypropylene resins.

2. The communication cable according to claim 1, wherein
the electric wire bundle is a twisted wire formed by twisting the plurality of insulated electric wires.

3. The communication cable according to claim 1, wherein
the base resin constituting the intermediate layer is at least one of a polyethylene resin or a polyethylene copolymer with a melting point of 140° C. or lower, and
the base resins constituting the covering layer and the sheath layer are polypropylene resins with a melting point of 160° C. or higher.

4. The communication cable according to claim 1, wherein
the covering layer contains 0.1 to 5.0 parts by mass of an antioxidant and 0.1 to 3.0 parts by mass of a copper inhibitor, relative to 100 parts by mass of the polypropylene resin.

5. The communication cable according to claim 1, wherein
the sheath layer contains 0 to 49 parts by mass of a flexible resin, relative to 51 to 100 parts by mass of the polypropylene resin, and
the sheath layer contains 0.1 to 5.0 parts by mass of an antioxidant and 60 to 150 parts by mass of a flame retardant, relative to 100 parts by mass of a total of the polypropylene resin and the flexible resin.

6. The communication cable according to claim 1, wherein
when the number of the insulated electric wires of the electric wire bundle is two, a thickness of the intermediate layer is 20 to 80% of a thickness of the sheath layer.
